(19) United States
(12) Patent Application Publication
(10) Pub. No.: US 2016/0146403 A1
(43) Pub. Date: May 26, 2016

(54) INTERMEDIATE FLUID TYPE VAPORIZER

(71) Applicant: KABUSHIKI KAISHA KOBE SEIKO SHO (KOBE STEEL, LTD.), Kobe-shi (JP)

(72) Inventors: Shinji EGASHIRA, Takasago-shi (JP); Haruyuki MATSUDA, Kobe-shi (JP)

(73) Assignee: Kabushiki Kaisha Kobe Seiko Sho (Kobe Steel, Ltd.), Kobe-shi, Hyogo (JP)

(21) Appl. No.: 14/787,558

(22) PCT Filed: Apr. 18, 2014
(86) PCT No.: PCT/JP2014/061027

§ 371 Date: Oct. 28, 2015

(30) Foreign Application Priority Data
May 8, 2013 (JP) 2013-098193

(51) Int. Cl. F17C 9/02; F28F 1/10

(52) U.S. Cl. CPC F17C 9/02; F28F 1/105; F17C 2221/033; F17C 2227/0318

(57) ABSTRACT

An intermediate fluid type vaporizer includes: an intermediate medium evaporator including a heat transfer tube through which seawater flows, and configured to evaporate at least a part of an intermediate medium in the form of a liquid on the outside of the heat transfer tube by heat exchange between the seawater and the intermediate medium; and an LNG evaporator including a heat transfer tube through which LNG flows, and configured to vaporize the LNG flowing through the heat transfer tube by condensing the intermediate medium evaporated in the intermediate medium evaporator on the outside of the heat transfer tube. The heat transfer tube is made of titanium or a titanium alloy. The outer circumferential surface of the heat transfer tube is formed with grooves having cavities for communicating with the outside via gaps formed in the outer surface of the heat transfer tube.

### TECHNICAL FIELD

The present invention relates to an intermediate fluid type vaporizer for heating and vaporizing a cryogenic liquid such as liquefied natural gas (hereinafter, called as LNG), using an intermediate medium such as propane.

### BACKGROUND ART

Conventionally, as disclosed in Patent Literature 1 and Patent Literature 2, there is known an intermediate fluid type vaporizer using an intermediate medium in addition to a heat source fluid, as a device for continuously vaporizing a cryogenic liquid such as LNG with a compact structure. As illustrated in FIG. 5, the intermediate fluid type vaporizer disclosed in Patent Literature 1 is provided with an intermediate medium evaporator E1, an LNG evaporator E2, and an NG (natural gas) heater E3. The vaporizer is further provided with an entrance chamber 50, multitudes of heat transfer tubes 52, an intermediate chamber 54, multitudes of heat transfer tubes 56, and an exit chamber 58 in this order, as a passage through which seawater as a heat source fluid flows. The heat transfer tubes 52 are disposed in the NG heater E3, and the heat transfer tubes 56 are disposed in the intermediate medium evaporator E2, respectively. An intermediate medium (e.g. propane) M whose boiling point is lower than the temperature of seawater is accommodated in the intermediate medium evaporator E1.

The LNG evaporator E2 is provided with an entrance chamber 62, an exit chamber 64, and multitudes of heat transfer tubes 63 for communicating between the entrance chamber 62 and the exit chamber 64. Each of the heat transfer tubes 63 has a substantially U-shape, and projects to the upper portion of the intermediate medium evaporator E1 within the intermediate medium evaporator E1. The exit chamber 64 is communicated with the NG heater E3 via an NG delivery tube 66.

In the vaporizer having the aforementioned configuration, seawater as a heat source fluid reaches the exit chamber 58 through the entrance chamber 50, the heat transfer tubes 52, the intermediate chamber 54, and the heat transfer tubes 56. When seawater passes through the heat transfer tubes 56, heat exchange is performed with the intermediate medium M in the form of a liquid within the intermediate medium evaporator E1, and as a result, the intermediate medium M is evaporated.

Meanwhile, LNG as a material to be vaporized is introduced into the heat transfer tubes 63 from the entrance chamber 62. Performing heat exchange between LNG in the heat transfer tubes 63, and the intermediate medium M which is evaporated in the intermediate medium evaporator E1 causes condensation of the intermediate medium M. LNG is evaporated to NG within the heat transfer tubes 63 while receiving the heat of condensation of the intermediate medium M. The NG is introduced from the exit chamber 64 into the NG heater E3 through the NG delivery tube 66. The NG is then heated by heat exchange with seawater flowing through the heat transfer tubes 52 within the NG heater E3, and is supplied to the user.

Patent Literature 3 discloses a heat transfer tube of boiling type for boiling coolant on the outside of the tube, while using seawater as a a heat source. The heat transfer tube for boiling coolant disclosed in Patent Literature 3 has a double tube structure provided with an inner tube made of titanium or stainless steel, and an outer tube made of copper or aluminum. Projections are formed on the outer circumferential surface of the outer tube by a rolling process. According to this configuration, the inner tube is made of titanium or stainless steel. Therefore, the inner tube has excellent resistance against seawater. Furthermore, the outer tube is made of copper or aluminum. Therefore, the outer tube has excellent rolling processability.

Patent Literature 1 and Patent Literature 2 do not describe the material of the heat transfer tube of the intermediate medium evaporator. However, generally, a heat transfer tube made of titanium or stainless steel is used as a heat transfer tube through which seawater flows, as exemplified by the aforementioned heat transfer tubes, taking into consideration resistance against seawater. The processing cost of a heat transfer tube made of titanium or stainless steel may be expensive. In view of the above, a bear tube (a finless tube) is used. However, in view of a point that a bear tube has low heat transfer performance, a heat transfer tube having substantially the same configuration as the heat transfer tube disclosed in Patent Literature 3 may be used as a heat transfer tube of an intermediate medium evaporator. The heat transfer tube disclosed in Patent Literature 3 has a double tube structure provided with an inner tube made of titanium or stainless steel, and an outer tube made of copper or aluminum, and projections are formed on the outer tube. According to this configuration, it is possible to secure rolling processability, and to secure resistance against seawater. However, in the heat transfer tube having a double tube structure disclosed in Patent Literature 3, the inner tube and the outer tube are made of different metals. Therefore, the inner tube and the outer tube have different linear expansion coefficients. According to this configuration, when heat exchange is performed between seawater flowing through the inner tube and the heat medium on the outside of the outer tube, peeling may occur between the inner tube and the outer tube. This may obstruct improvement of heat transfer performance as intended.

### CITATION LIST

### Patent Literature

Patent Literature 1: Japanese Unexamined Patent Publication No. 2000-227200

Patent Literature 2: Japanese Unexamined Patent Publication No. 2001-200995

Patent Literature 3: Japanese Unexamined Patent Publication No. 2012-2374

### SUMMARY OF INVENTION

An object of the invention is to provide an intermediate fluid type vaporizer that enables to secure resistance against seawater, and to improve heat transfer performance.

An intermediate fluid type vaporizer according to an aspect of the invention is provided with an intermediate medium evaporation unit including a heat transfer tube through which seawater flows, and configured to evaporate at least a part of an intermediate medium in the form of a liquid on the outside of the heat transfer tube by heat exchange between the seawater flowing through the heat transfer tube and the intermediate medium; and a liquefied gas vaporization unit including a heat transfer tube through which cryogenic liquefied gas flows, and configured to vaporize the cryogenic liquefied gas flowing through the heat transfer tube by condensing the intermediate medium evaporated in the intermediate medium evaporation unit. The heat transfer tube of the intermediate medium evaporation unit is made of titanium or a titanium alloy. The outer circumferential surface of the heat transfer tube is formed with grooves having cavities communicating with the outside via gaps formed on the outer surface of the heat transfer tube.

### BRIEF DESCRIPTION OF DRAWINGS

FIG. 1 is a diagram schematically illustrating the configuration of an intermediate fluid type vaporizer embodying the invention;

FIG. 2 is a diagram schematically illustrating a part of the outer appearance of a heat transfer tube of an intermediate medium evaporator incorporated in the vaporizer;

FIG. 3 is a cross-sectional view partly illustrating the heat transfer tube;

FIG. 4 is a cross-sectional view schematically illustrating a heat transfer tube of an LNG evaporator incorporated in the vaporizer; and

FIG. 5 is a diagram schematically illustrating the configuration of a conventional intermediate fluid type vaporizer.

### DESCRIPTION OF EMBODIMENT

In the following, an embodiment of the invention is described in detail referring to the drawings.

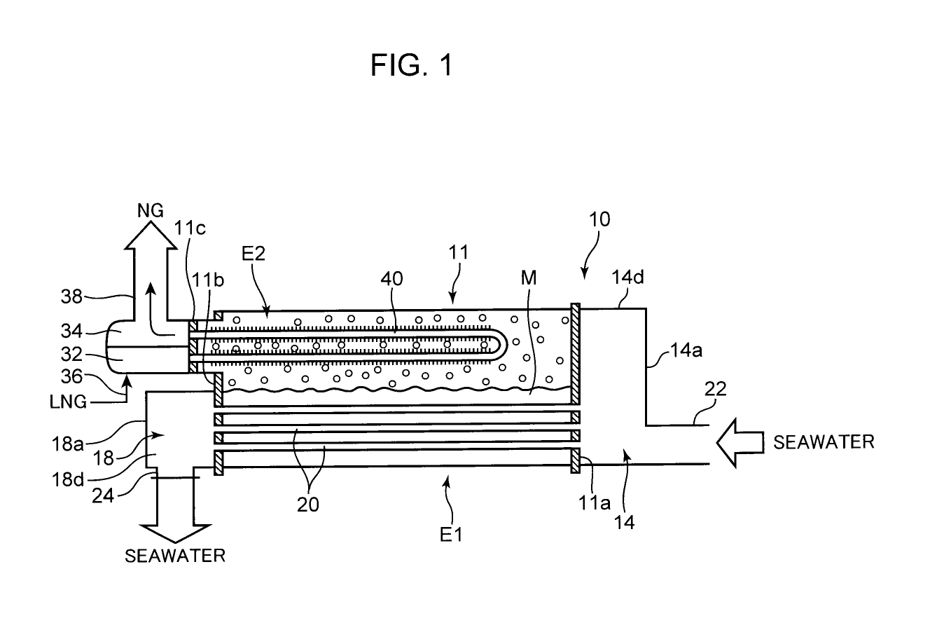

As illustrated in FIG. 1, an intermediate fluid type vaporizer (hereinafter, simply called as a vaporizer) 10 according to the embodiment is a device for transferring heat of seawater as a heat source fluid to LNG (liquefied natural gas), which is cryogenic liquefied gas, via an intermediate medium, and vaporizing the LNG. The vaporizer 10 is provided with an intermediate medium evaporator E1 as an intermediate medium evaporation unit, and an LNG evaporator E2 as a liquefied gas vaporization unit. The vaporizer 10 is provided with a hollow main body unit 11. The main body unit 11 serves as a shell of the intermediate medium evaporator E1.

One side portion of the intermediate medium evaporator E1 is adjacent to an entrance chamber (water chamber) 14, and a lower portion of the other side portion of the intermediate medium evaporator E1 is adjacent to an exit chamber 18. Multitudes of heat transfer tubes 20 are disposed in the intermediate medium evaporator E1. The heat transfer tubes 20 are disposed in the lower portion of the main body unit 11. The heat transfer tubes 20 are bridged between an entrance side wall (entrance side tube plate) 11a out of the side walls of the main body unit 11, and an exit side wall (exit side tube plate) 11b out of the side walls of the main body unit 11. The entrance side wall 11a serves as a partition wall with respect to the entrance chamber 14. The exit side wall 11b serves as a partition wall with respect to the exit chamber 18. Each of the heat transfer tubes 20 has a shape linearly extending in one direction. The shape of the heat transfer tube 20, however, is not limited to the above.

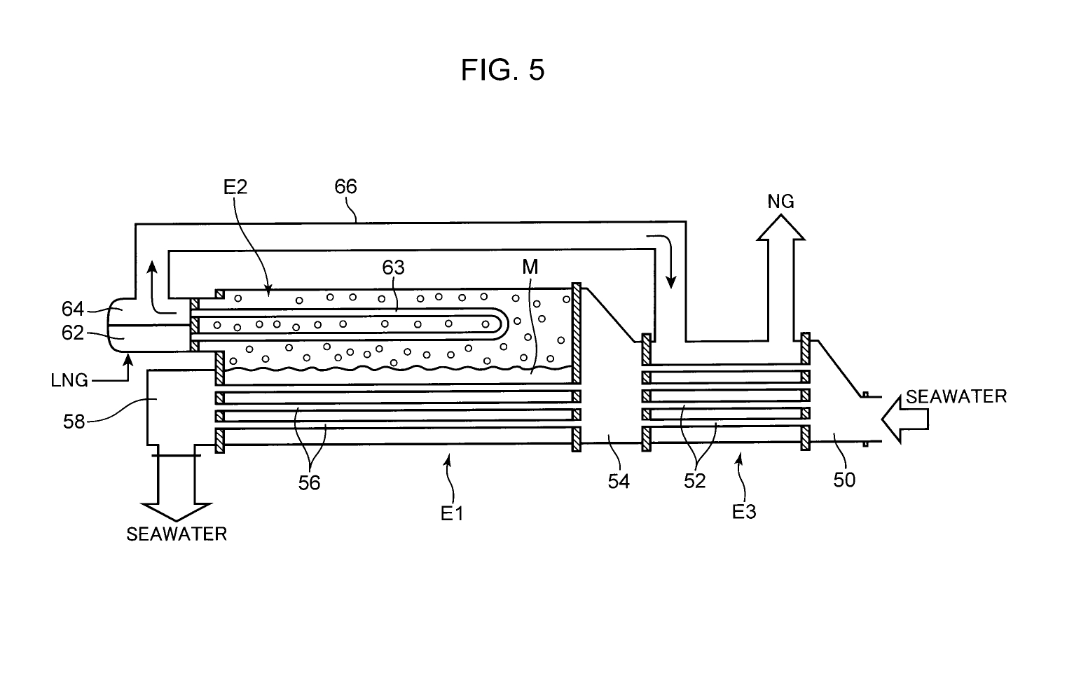

The entrance chamber 14 is provided with an outer side wall 14a disposed away from the entrance side tube plate 11a by a distance, and a connection wall 14d for connecting between the entrance side tube plate 11a and the outer side wall 14a. The outer side wall 14a is connected to an introduction tube 22 for introducing seawater. The introduction tube 22 is provided with an unillustrated pump so that seawater pumped up from the sea is introduced into the entrance chamber 14. Specifically, unlike the conventional intermediate fluid type vaporizer illustrated in FIG. 5, the vaporizer 10 in the embodiment is not provided with an NG heater. Therefore, there is no likelihood that seawater before being introduced into the entrance chamber 14 is used for warming NG. The configuration of the introduction tube 22 is not limited to the configuration such that the introduction tube 22 is connected to the outer side wall 14a.

The exit chamber 18 is provided with an outer side wall 18a disposed away from the exit side tube plate 11b by a distance, and a connection wall 18d for connecting between the exit side tube plate 11b and the outer side wall 18a. The connection wall 18d is connected to a discharge tube 24 for discharging seawater. The configuration of the discharge tube 24 is not limited to the configuration such that the discharge tube 24 is connected to the connection wall 18d. The discharge tube 24 may be connected to the outer side wall 18a.

An intermediate medium (e.g. propane) M whose boiling point is lower than the temperature of seawater is accommodated in the intermediate medium evaporator E1 within the main body unit 11. The intermediate medium M is accommodated in such a manner that the liquid level of the intermediate medium M is higher than all the heat transfer tubes (heat transfer tubes through which seawater flows) 20.

An entrance chamber 32 for LNG, and an exit chamber 34 for delivering NG are formed above the exit chamber 18. The entrance chamber 32 and the exit chamber 34 are adjacent to the upper portion of the intermediate medium evaporator E1 via a tube plate 11c, which constitutes the other side wall of the main body unit 11 in cooperation with the exit side tube plate 11b. The exit chamber 34 is formed to be adjacent to the upper portion of the entrance chamber 32. The entrance chamber 32 is connected to a supply tube 36 for introducing LNG. The exit chamber 34 is connected to a delivery tube 38 for delivering NG. NG is supplied to the user through the delivery tube 38.

The LNG evaporator E2 is provided with the entrance chamber 32, the exit chamber 34, and multitudes of heat transfer tubes 40 for communicating between the entrance chamber 32 and the exit chamber 34. The heat transfer tubes 40 are disposed in the upper portion of the main body unit 11. Each of the heat transfer tubes 40 has a substantially U-shape. Both ends of the heat transfer tube 40 are fixed to the tube plate 11c in a state that the heat transfer tube 40 projects into the upper portion of the main body unit 11. The heat transfer tubes 40 are disposed at a position higher than the liquid level of the intermediate medium M.

The vaporizer 10 in the embodiment is configured such that seawater is introduced into the entrance chamber 14 through the introduction tube 22. The seawater flows into the heat transfer tubes 20 of the intermediate medium evaporator E1. The seawater flowing through the heat transfer tubes 20 is subjected to heat exchange with the intermediate medium M in the form of a liquid. By the heat exchange, the intermediate medium M in the form of a liquid is boiled and vaporized.

Meanwhile, LNG as a material to be vaporized is introduced into the entrance chamber 32 through the supply tube 36. The LNG flows from the entrance chamber 32 into the heat transfer tubes 40 of the LNG evaporator E2. Performing heat exchange between LNG in the heat transfer tubes 40 and the intermediate medium M in the form of a gas within the intermediate medium evaporator E1 (within the main body unit 11) causes condensation of the intermediate medium M on the outside of the heat transfer tubes 40. LNG is vaporized to NG within the heat transfer tubes 40 while receiving the heat of condensation. The NG is supplied from the exit chamber 34 to the user through the delivery tube 38. Specifically, NG vaporized in the LNG evaporator E2 is supplied to the user while keeping the temperature thereof unchanged, without being heated. In the LNG evaporator E2, NG is heated to the temperature of e.g. 0° C. or higher. The embodiment is not limited to a configuration, in which NG is heated to the temperature of 0° C. or higher in the LNG evaporator E2. It is possible to change the temperature of NG to be discharged from the LNG evaporator E2 in accordance with a request from the user. The temperature of NG may be lower than 0 ° C. In this case, it is also possible to supply NG delivered from the LNG evaporator E2 to the user, without further heating the NG.

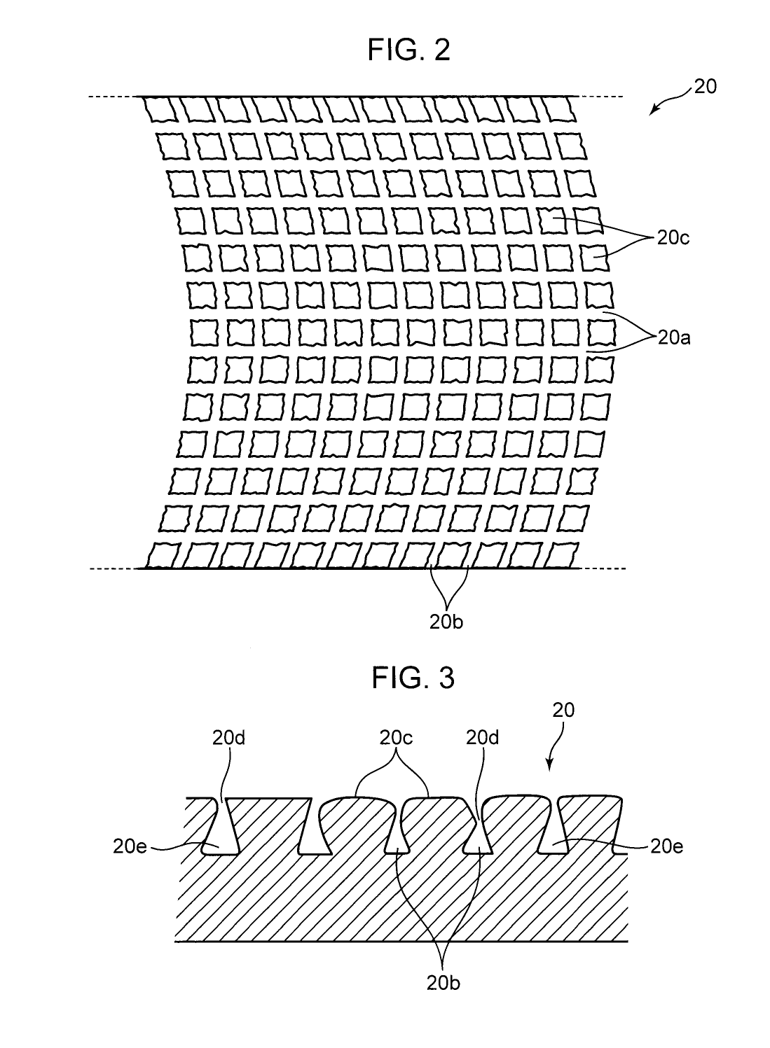

In the following, the configuration of the heat transfer tube 20 provided in the intermediate medium evaporator E1 is described. The heat transfer tube 20 is made of titanium or a titanium alloy. As illustrated in FIG. 2, the outer circumferential surface of the heat transfer tube 20 is formed with grooves 20a and 20b in the form of a mesh. Specifically, the outer circumferential surface of the heat transfer tube 20 is formed with multitudes of the grooves 20a extending in the length direction (axis direction) of the heat transfer tube 20 and multitudes of the grooves 20b extending in the circumferential direction of the the heat transfer tube 20. Portions between the grooves adjacent to each other are formed as convex portions 20c. The multitudes of the convex portions 20c are axially and circumferentially disposed. In the embodiment, the grooves are constituted by the lengthwise grooves 20a and the circumferential grooves 20b. The embodiment is not limited to the above. For instance, the grooves may be constituted only by multitudes of lengthwise grooves 20a, without circumferential grooves 20b. Further alternatively, the grooves may be constituted only by multitudes of circumferential grooves 20b, without lengthwise grooves 20a. In other words, the grooves 20a and 20b may not be formed in a mesh shape.

The convex portions 20c can be formed by applying surface treatment to the outer surface of the heat transfer tube 20 by e.g. crushing after a rolling process. According to the aforementioned configuration, as illustrated in FIG. 3, the outer end surface of the convex portion 20c has an approximately flat shape. The groove 20a, 20b between the adjacent convex portions 20c has such a shape that the width of a cavity 20e of the groove on the deep side of the groove is larger than the width of a gap 20d of the groove on the outer surface side of the heat transfer tube 20. Thus, the groove 20a, 20b between the convex portions 20c is a tunnel-like groove opened outward. Specifically, the grooves 20a and 20b are formed between the convex portions 20c in such a manner that the grooves have the cavities 20e communicating with the outside via the gaps 20d formed on the outer surface of the heat transfer tube 20. Forming the outer surface of the heat transfer tube 20 to have the aforementioned shape is advantageous in promoting boiling.

In the embodiment, the groove 20a, 20b between the adjacent convex portions 20c is formed to have such a shape that the width of the cavity 20e of the groove on the deep side of the groove is larger than the width of the gap 20d of the groove on the outer surface side of the heat transfer tube 20. However, the shape of the groove 20a, 20b in the outer circumferential surface of the heat transfer tube 20 is not limited to the above.

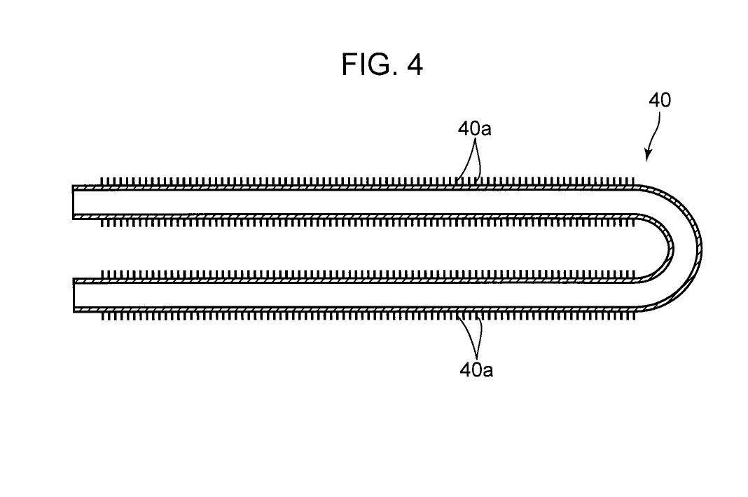

As illustrated in FIG. 4, the heat transfer tube 40 disposed in the LNG evaporator E2 is constituted by a finned tube. Since the heat transfer tube 40 has a U-shape, multitudes of fins 40a are axially aligned on a straight portion of the heat transfer tube 40. The convex portions 20c are formed on the outer circumferential surface of the heat transfer tubes 20 of the intermediate medium evaporator E1. Further, the heat transfer tube 40 of the LNG evaporator E2 is constituted by a finned tube. Therefore, the embodiment is advantageous in obtaining heat transfer performance of about two times as high as the heat transfer performance of the conventional art.

The heat transfer tube 40 is not formed with a convexo-concave inner surface. Alternatively, the heat transfer tube 40 may be formed with a convexo-concave inner surface. The aforementioned modification is advantageous in improving the heat exchange performance. Further, an unillustrated heat transfer promoter may be disposed in the heat transfer tube 40. The heat transfer promoter is, for instance, a helical tape (a twisted tape), a member obtained by aligning a plurality of curved plate-liked pieces, a wire insert, or a member obtained by knitting filaments. The heat transfer promoter promotes turbulence of liquefied natural gas within the heat transfer tube 40.

As described above, in the embodiment, the heat transfer tubes 20 of the intermediate medium evaporator E1 are made of titanium or a titanium alloy. Therefore, even when seawater flows through the heat transfer tubes 20, the heat transfer tubes 20 are less likely to be corroded. Thus, it is possible to secure resistance against seawater. Further, unlike a conventional double tube structure, the heat transfer tube 20 is a one-piece product. Therefore, there is no likelihood that peeling occurs between the inner tube and the outer tube. As a result, there is no likelihood that the heat transfer performance is deteriorated on the wall of the hear transfer tube. Furthermore, the outer circumferential surface of the heat transfer tube 20 of the intermediate medium evaporator E1 is formed with the grooves 20a and 20b having the cavities 20e for communicating with the outside. This is advantageous in improving the heat transfer performance of the intermediate medium evaporator E1.

In the embodiment, the heat transfer tube 40 of the LNG evaporator E2 is constituted by a finned tube. Therefore, it is possible to increase the contact surface of the intermediate medium M in the heat transfer tube 40. This is also advantageous in improving the heat transfer performance even in the LNG evaporator E2.

Further, in the embodiment, gas vaporized in the LNG evaporator E2 is supplied to the user through the delivery tube 38, without the need of additional heating. Specifically, as the heat transfer tube 20 of the intermediate medium evaporator E1, there is used the heat transfer tube 20 configured such that the grooves 20a and 20b having the cavities 20e are formed in the outer circumferential surface of the heat transfer tube 20, and a finned tube is used as the heat transfer tube 40 of the LNG evaporator E2. According to this configuration, it is possible to heat LNG (cryogenic liquefied gas) in the LNG evaporator E2 to a temperature at which further heating is not necessary within the delivery tube 38. Thus, it is not necessary to provide a heater (NG heater), unlike the conventional art. Therefore, it is possible to absorb the cost, which may be raised regarding the cost of the heat transfer tubes 20 of the intermediate medium evaporator E1 and regarding the cost of the heat transfer tubes 40 of the LNG evaporator E2. Thus, it is possible to implement cost reduction in total, as compared with a conventional device. Further, in the embodiment, an NG heater is omitted. This makes it possible to reduce the installation area of the vaporizer 10, as compared with a conventional configuration. This is advantageous in installing the vaporizer on a ship in which the installation space is limited.

The invention is not limited to the embodiment, and a variety of modifications and alterations may be applied, as far as such modifications and alterations do not depart from the gist of the invention. For instance, in the embodiment, the heat transfer tube 40 provided in the LNG evaporator E2 is constituted by a finned tube. The invention is not limited to the above. The heat transfer tube 40 provided in the LNG evaporator E2 may be constituted by a bear tube (a finless tube).

In the embodiment, an NG heater is omitted. The invention is not limited to the above. An NG heater may be provided for the delivery tube 38 to further heat NG in the delivery tube 38.

The following is a summary of the embodiment.

(1) In the embodiment, the heat transfer tube of the intermediate medium evaporation unit is made of titanium or a titanium alloy. Therefore, even when seawater flows through the heat transfer tube, the heat transfer tube is less likely to be corroded. Thus, it is possible to secure resistance against seawater. Further, unlike a conventional double tube structure, the heat transfer tube is a one-piece product. Therefore, there is no likelihood that peeling occurs between the inner tube and the outer tube. As a result, there is no likelihood that the heat transfer performance is deteriorated on the wall of the hear transfer tube. Furthermore, the outer circumferential surface of the heat transfer tube of the intermediate medium evaporation unit is formed with the grooves having the cavities for communicating with the outside via the gaps formed in the outer surface of the heat transfer tube. This is advantageous in improving the heat transfer performance of the intermediate medium evaporation unit.

(2) The heat transfer tube of the liquefied gas vaporization unit may be constituted by a finned tube made of stainless steel. According to this configuration, the heat transfer tube of the liquefied gas vaporization unit is constituted by a finned tube. Therefore, it is possible to increase the contact surface of the intermediate medium in the heat transfer tube. This is also advantageous in improving the heat transfer performance even in the liquefied gas vaporization unit.

(3) The liquefied gas vaporization unit may include an exit chamber into which gas vaporized in the heat transfer tube flows. The exit chamber may be connected to a delivery tube for supplying gas flowing out of the exit chamber to the user, without heating the gas. According to this configuration, gas vaporized in the liquefied gas vaporization unit is supplied to the user through the delivery tube. Specifically, as the heat transfer tube of the intermediate medium evaporation unit, there is used a heat transfer tube configured such that the outer circumferential surface of the heat transfer tube is formed with grooves having cavities communicating with the outside via gaps formed on the outer surface of the heat transfer tube, and a finned tube is used as the heat transfer tube of the liquefied gas vaporization unit. According to this configuration, it is possible to heat the cryogenic liquefied gas in the liquefied gas vaporization unit to a temperature at which further heating is not necessary within the delivery tube. Thus, it is not necessary to provide a heater (NG heater), unlike the conventional art. Therefore, it is possible to absorb the cost, which may be raised regarding the cost of the heat transfer tube of the intermediate medium evaporation unit, and regarding the cost of the heat transfer tube of the liquefied gas vaporization unit. Thus, it is possible to implement cost reduction in total, as compared with a conventional device.

As described above, according to the embodiment, it is possible to secure resistance against seawater, and to improve heat transfer performance.

1. An intermediate fluid type vaporizer, comprising:
an intermediate medium evaporation unit including a heat transfer tube through which seawater flows, and configured to evaporate at least a part of an intermediate medium in the form of a liquid on the outside of the heat transfer tube by heat exchange between the seawater in the heat transfer tube and the intermediate medium; and
a liquefied gas vaporization unit including a heat transfer tube through which cryogenic liquefied gas flows, and configured to vaporize the cryogenic liquefied gas flowing through the heat transfer tube by condensing the intermediate medium evaporated in the intermediate medium evaporation unit, wherein
the heat transfer tube of the intermediate medium evaporation unit is made of titanium or a titanium alloy, and an outer circumferential surface of the heat transfer tube is formed with grooves having cavities communicating with the outside via gaps formed on an outer surface of the heat transfer tube.

2. The intermediate fluid type vaporizer according to claim 1, wherein
the heat transfer tube of the liquefied gas vaporization unit is constituted by a finned tube made of stainless steel.

3. The intermediate fluid type vaporizer according to claim 2, wherein
the liquefied gas vaporization unit includes an exit chamber into which gas vaporized in the heat transfer tube flows, and
the exit chamber is connected to a delivery tube for supplying gas flowing out of the exit chamber to a user, without heating the gas.
